(19) United States
(12) Patent Application Publication
(10) Pub. No.: US 2026/0141414 A1
(43) Pub. Date: May 21, 2026

(54) RESPONDING TO QUERIES BY GENERATING A SYNTHETIC AUDIENCE OF RESPONDENTS

(71) Applicant: Qualtrics, LLC, Provo, UT (US)

(72) Inventors: Ali Rohani, San Diego, CA (US); Alison Henriques, Salt Lake City, UT (US); Gurdeep Pall, Seattle, WA (US); Matthew Oberhardt, Seattle, WA (US); Kalyan Basu, Sammamish, WA (US); Mark Masterton, Salt Lake City, UT (US); Derrick McLean, Palatine, IL (US); Karen M. Goldstein, Chicago, IL (US); Kristjan Arumae, Seattle, WA (US); Nick Mansfield, Lehi, UT (US); Sherwin Lee, Bellevue, WA (US); David Nichols, Seattle, WA (US); Recep Colak, Seattle, WA (US); Daniel Perry, Reston, VA (US); Prashant Shiralkar, Sammamish, WA (US); Adrienne Boissy, Chagrin Falls, OH (US)

(21) Appl. No.: 19/059,854

(22) Filed: Feb. 21, 2025

Related U.S. Application Data
(60) Provisional application No. 63/721,290, filed on Nov. 15, 2024.

(51) Int. Cl. G06Q 30/0203; G06F 40/40; G06Q 30/0204

(52) U.S. Cl. CPC G06Q 30/0203; G06F 40/40; G06Q 30/0204

(57) ABSTRACT

The present disclosure relates to systems, non-transitory computer-readable media, and methods for using a synthetic audience to respond to queries. For example, in one or more embodiments, the disclosed systems receive, from a client device, a query for informational responses from an audience of respondents. The disclosed systems further generate, using a large language model and in response to the query, a set of informational responses from a set of synthetic respondents. Additionally, the disclosed systems provide, for display on the client device, a presentation of the set of informational responses from the set of synthetic respondents.

### CROSS-REFERENCE TO RELATED APPLICATIONS

This application claims priority to U.S. Provisional Application No. 63/721,290, entitled “RESPONDING TO QUERIES BY GENERATING A SYNTHETIC AUDIENCE OF RESPONDENTS,” filed Nov. 15, 2024, the full disclosure of which is incorporated herein by reference.

### BACKGROUND

Recent years have seen significant advancement in hardware and software platforms that facilitate communications between entities and implement analytical tools and features with respect to those communications. For instance, systems have developed to enable some entities (e.g. users) to generate and provide targeted and nuanced feedback to other entities (e.g., a businesses or other organizations) regarding products and/or services offered by those other entities. In some cases, such systems enable feedback to be provided actively, such as by using electronic surveys. In some instances, such systems enable the feedback to be provided passively, such as through tracking the journeys (e.g., touchpoints) of users as they interact with a digital system. These conventional systems, however, often implement inflexible, inefficient, and expensive processes for facilitating the acquisition of feedback.

### SUMMARY

Embodiments of the present disclosure provide benefits and/or solve one or more of the foregoing or other problems in the art with systems, non-transitory computer-readable media, and methods that implement artificial intelligence to generate targeted feedback from a synthetic audience. For instance, the disclosed systems can use a large language model to generate responses that incorporate feedback or other information with respect to a submitted query. In particular, the disclosed systems can use the large language model to generate responses from an audience of synthetic respondents. In some cases, the disclosed systems generate personas for the synthetic respondents and generate the responses to reflect those personas. In some instances, the disclosed systems use the responses from the synthetic audience to supplement responses from a human audience. Further, in some embodiments, the disclosed systems periodically update parameters of the large language model (e.g., based on evaluations made using another large language model) to maintain the relevancy and improve the accuracy of generated responses. In this manner, the disclosed systems implement a unique and efficient process for obtaining feedback.

Additional features and advantages of one or more embodiments of the present disclosure are outlined in the description which follows, and in part can be determined from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates a synthetic response system generating informational responses to a query via a synthetic audience in accordance with one or more embodiments.

FIG. 2 illustrates the synthetic response system generating one or more informational responses from an audience segment in accordance with one or more embodiments.

FIG. 3 illustrates the synthetic response system using a synthetic audience to supplement a human audience in accordance with one or more embodiments.

FIG. 4 illustrates the synthetic response system generating informational responses for a target context in accordance with one or more embodiments.

FIG. 5 illustrates the synthetic response system training a large language model in accordance with one or more embodiments.

FIG. 6 illustrates the synthetic response system evaluating the performance of a large language model in accordance with one or more embodiments.

FIG. 7 illustrates the synthetic response system configuring a machine learning model to adhere to a set of standards in accordance with one or more embodiments.

FIG. 8 illustrates an example environment in which a synthetic response system operates in accordance with one or more embodiments.

FIG. 9 illustrates a flowchart of a series of acts for responding to a query using a synthetic audience in accordance with one or more embodiments.

FIG. 10 illustrates a block diagram of an exemplary computing device in accordance with one or more embodiments.

FIG. 11 illustrates a network environment of a synthetic response system in accordance with one or more embodiments.

### DETAILED DESCRIPTION

One or more embodiments described herein include a synthetic response system that generates responses to queries via synthetic audiences created using artificial intelligence. For example, in some embodiments, the synthetic response system creates a synthetic audience using a large language model. The synthetic response system can use the synthetic audience to generate responses to a query. In some cases, each response reflects an individual persona based on underlying data (e.g., behavioral data) and/or a background narrative created for a corresponding synthetic respondent. In some instances, the synthetic response system generates the responses for a particular audience segment or a targeted context defined by the query. In certain embodiments, the synthetic response system configures (e.g., trains or updates) the large language model using curated training data (e.g., human-based training data, synthetic training data, and/or value-based training data) and/or particular evaluation techniques (e.g., using an additional language model to evaluate generated responses).

To illustrate, in one or more embodiments, the synthetic response system receives, from a client device, a query for informational responses from an audience of respondents. The synthetic response system further generates, using a large language model and in response to the query, a set of informational responses from a set of synthetic respondents. Additionally, the synthetic response system provides, for display on the client device, a presentation of the set of informational responses from the set of synthetic respondents.

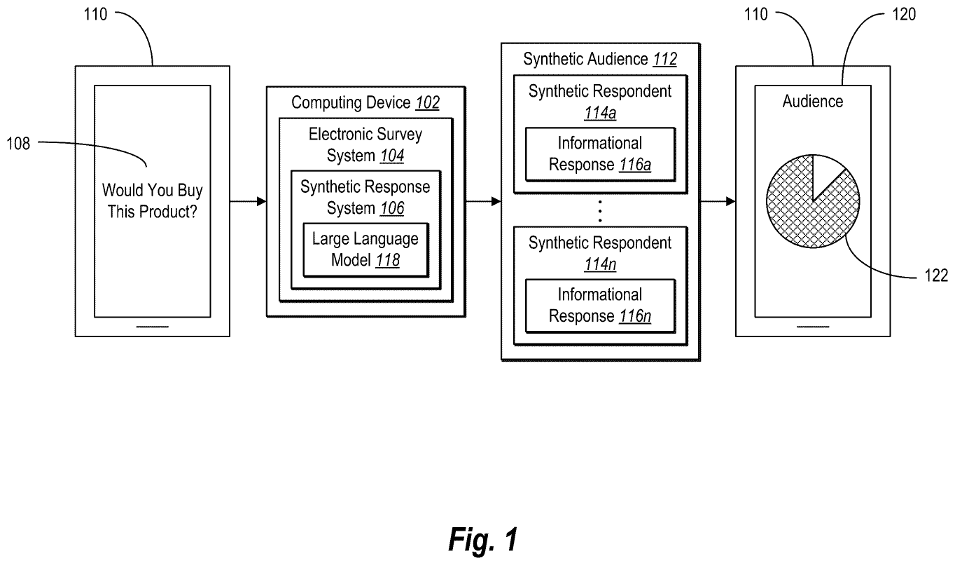

As mentioned, in one or more embodiments, the synthetic response system responds to queries submitted by client devices by generating informational responses to a query via a synthetic audience. FIG. 1 illustrates the synthetic response system generating informational responses to a query via a synthetic audience in accordance with one or more embodiments.

In particular, FIG. 1 illustrates a synthetic response system 106 operating on a computing device 102. Further, FIG. 1 illustrates the synthetic response system 106 operating as part of an electronic survey system 104. For instance, in some cases, the synthetic response system 106 operates as a sub-system of the electronic survey system 104 hosted on the computing device 102. Though FIG. 1. illustrates the synthetic response system 106 operating in the context of electronic surveys, it should be understood that the synthetic response system 106 can operate in various contexts in various implementations (e.g., as part of other systems or as its own system). For example, in certain cases, the synthetic response system 106 operates as part of an experience management system that receives feedback from users'digital journeys (e.g., touchpoints leading to conversion or abandonment) and provides experiences (e.g., personalized content) based on that feedback. Thus, the synthetic response system 106 can generate informational responses in contexts in which responses would otherwise be obtained from respondents actively or passively.

As shown in FIG. 1, the synthetic response system 106 receives a query 108 from a client device 110. The query 108 shown in FIG. 1 includes a request for information. In particular, the query 108 includes a question asking for feedback on a product (e.g., a product for which market research is being performed). In some instances, the query 108 includes a survey question. For instance, the query 108 can include a survey question taken from a collection of survey questions from an electronic survey. A query, however, can include various types of questions or other requests for information and is not limited to the context of a product.

In some cases, the client device 110 is associated with the topic of the query 108. For instance, in some cases, the client device 110 is associated with an entity (e.g., business, group, or individual) developing, manufacturing, or selling the product for which information is requested or a third-party operating on behalf of such an entity.

In one or more embodiments, the query 108 requests informational responses from an audience of respondents. In particular, the query 108 can request informational responses from a plurality of respondents. In some instances, however, the query 108 requests an informational response from a single respondent. The number of respondents (e.g., the size of the audience) from which responses are requested can be explicitly stated or implicit within the query 108. In some cases, the synthetic response system 106 uses a default number of respondents unless a different number is expressed within the query 108. In some embodiments, the synthetic response system 106 requests, via the client device 110, for user input indicating the number of respondents to use.

As will be discussed below, the query 108 can include information in addition to the question to be answered. For instance, in some cases, the query 108 includes information, such as constraints, regarding the audience (or audience segment) from which informational responses are requested. In some embodiments, the query 108 includes information regarding how informational responses are to be used. Further, in certain cases, the query 108 indicates a target context for which the informational responses are to be generated.

As shown in FIG. 1, in response to the query 108, the synthetic response system 106 generates a set of informational responses 116a-116n. In particular, the synthetic response system 106 generates the set of informational responses 116a-116n from a set of synthetic respondents 114a-114n. Indeed, the synthetic response system 106 can determine to use a synthetic audience 112 for responding to the query 108. The synthetic response system 106 can generate the set of synthetic respondents 114a-114n to populate the synthetic audience 112. Further, the synthetic response system 106 can generate the set of informational responses 116a-116n by generating an informational response for each synthetic respondent.

Indeed, for each synthetic respondent, the synthetic response system 106 can generate an informational response that reflects a response to the query 108 from that synthetic respondent. For instance, the synthetic response system 106 can generate an informational response that reflects a response from a synthetic respondent by generating an informational response that reflects one or more preferences, one or more behaviors, a background, and/or one or more personality traits of that synthetic respondent.

In one or more embodiments, the synthetic response system 106 generates the set of synthetic respondents 114a-114n and further generates the set of informational responses 116a-116n as separate steps. To illustrate, the synthetic response system 106 can generate the set of synthetic respondents 114a-114n by generating personas or profiles for the set of synthetic respondents 114a-114n (e.g., generating one or more preferences, one or more behaviors, a background, and/or one or more personality traits for each synthetic respondent). In some embodiments, however, generating the set of synthetic respondents 114a-114n is inherent to generating the set of informational responses 116a-116n. For instance, rather than generating the set of synthetic respondents 114a-114n expressly, the synthetic response system 106 can implicitly generate the set of synthetic respondents 114a-114n by generating the set of informational responses 116a-116n to reflect the set of synthetic respondents 114a-114n.

As shown in FIG. 1, the synthetic response system 106 uses a large language model 118 to generate the set of informational responses 116a-116n from the set of synthetic respondents 114a-114n. For example, the synthetic response system 106 can provide the query 108 as part of a prompt to the large language model 118. As previously suggested, in some cases, the synthetic response system 106 further provides information in addition to the query 108 illustrated in FIG. 1 (e.g., additional information as part of the query 108 or as another component of the prompt).

As further suggested, in one or more embodiments, the synthetic response system 106 uses the large language model 118 to generate the set of synthetic respondents 114a-114n in response to the query 108. For instance, as will be discussed in more detail below, the synthetic response system 106 can use the large language model 118 to generate personas and/or profiles that are representative of the set of synthetic respondents 114a-114n upon receiving the query 108. Thus, the synthetic response system 106 can use the large language model 118 to generate the set of informational responses 116a-116n using the generated synthetic respondents.

In some embodiments, rather than generating the set of synthetic respondents 114a-114n upon receiving the query 108, the synthetic response system 106 maintains a dataset of pre-generated synthetic respondents. To illustrate, before receiving the query 108, the synthetic response system 106 can generate (e.g., using the large language model 118) a plurality of synthetic respondents and store the generated synthetic respondents for use in responding to queries. Thus, in certain embodiments, the synthetic response system 106 refers to the stored synthetic respondents upon receiving the query 108 to generate the set of informational responses 116a-116n. For instance, the synthetic response system 106 can provide a dataset of the stored synthetic respondents (or a subset thereof) as part of a prompt to the large language model 118 for responding to the query 108. Indeed, in some cases, the set of synthetic respondents 114a-114n includes the stored synthetic respondents or a subset thereof.

As further shown in FIG. 1, the synthetic response system 106 provides a presentation 122 of the set of informational responses 116a-116n for display on the client device 110. In particular, the synthetic response system 106 provides the presentation 122 for display within a graphical user interface 120 of the client device 110.

As indicated by FIG. 1, the presentation 122 can include a graphical representation (e.g., a chart or graph) of the set of informational responses 116a-116n. In some cases, the presentation 122 includes a textual or audio presentation. Thus, in some cases, the synthetic response system 106 generates the presentation 122 from the set of informational responses 116a-116n via one or more aggregation, summarization, derivation, or other processing techniques. In some cases, however, the synthetic response system 106 presents the set of informational responses 116a-116n themselves such that each informational response is displayed individually. In some cases, the synthetic response system 106 provides one or more selectable options within the graphical user interface 120 for viewing different aspects of the presentation 122. For instance, the synthetic response system 106 can provide one or more selectable options for selecting a particular portion of a graph or chart and, upon detecting a selection, provide more information regarding the informational responses represented by the selected portion.

As mentioned above, conventional feedback systems often suffer from several technological shortcomings that result in inflexible and inefficient operation. Further, the methods of these conventional systems can be very expensive to implement—often prohibitively expensive.

To illustrate, conventional feedback systems are often inflexible in that they rigidly rely on some degree of human activity to obtain useful feedback. For example, as previously mentioned, some conventional systems facilitate the acquisition of feedback through electronic surveys. Under such systems, feedback is generated and received based on user interactions with a client device to input responses to survey questions. While some conventional systems obtain feedback via more passive methods, they still require human activity. For instance, conventional systems that obtain passive feedback by monitoring user interactions with a digital system still require a user to actually interact with the digital system. In other words, whether feedback is obtained through active or passive means, conventional systems rely on users to interact with a client device to provide such feedback.

Additionally, conventional feedback systems are typically inefficient in that they consume a lot of computing resources to obtain feedback. For instance, when obtaining feedback through the use of electronic surveys, conventional systems require computational resources to create the electronic surveys. Such systems further require the computational resources of the client devices of human survey respondents to respond to the electronic surveys. Transmitting electronic surveys to the client devices and transmitting responses from the client devices back to the synthetic response system 106 consumes additional resources, including network bandwidth.

Not only are conventional systems computationally expensive, such systems also involve a real-world investment that is often times prohibitive, barring entities that lack the required time and money from obtaining useful feedback. For instance, conventional systems are often employed as part of a campaign to gather enough feedback to obtain a thorough understanding of an entity's position within a market, the likely success of a product or service that has yet to be launched, or the views of those who have engaged with a product or service that has already been launched. Creating an electronic survey meant to obtain the precise feedback desired, identifying the desired audience segment, connecting with potential recipients from the audience segment, providing the electronic survey, and retrieving responses are requires real-world man hours (often on the order of hundreds of hours) and dollars (often on the order of tens or hundreds of thousands of dollars) to implement.

The synthetic response system 106 provides several advantages over conventional feedback systems. For instance, the synthetic response system 106 operates with improved flexibility when compared to many conventional systems. To illustrate, the synthetic response system 106 flexibly generates and provides feedback in response to queries without relying on human activity. Indeed, by generating informational responses from a synthetic audience, the synthetic response system 106 flexibly uncouples feedback from the involvement of human participants. Thus, the synthetic response system 106 can freely and almost instantaneously produce results in response to queries in many cases.

Additionally, the synthetic response system 106 provides improved efficiency when compared to conventional feedback systems. In particular, the synthetic response system 106 reduces the computing resources typically consumed under conventional systems to acquire feedback. For instance, the synthetic response system 106 reduces computing resources (e.g., network bandwidth) typically consumed to transmit electronic surveys to the client devices of respondents and to receive their responses in return. Further, the synthetic response system 106 reduces the interactions with a client device typically required of respondents under conventional systems. Indeed, in many cases, the synthetic response system 106 entirely eliminates the need for a respondent to engage with a client device to generate and provide a response to an electronic survey.

Further, the synthetic response system 106 offers a new and unique approach to acquiring feedback that reduces the real-world costs associated with many conventional feedback systems. In particular, the synthetic response system 106 changes the foundation of acquiring feedback from a data-gathering-based approach to a data-generation-based approach. For instance, by receiving a query, using a large language model to generate informational responses from a synthetic audience in response to the query, and providing a presentation of the generated responses, the synthetic response system 106 implements an unconventional combination of steps to complete a task (i.e., feedback acquisition) that is completed via a significantly different process under conventional systems. As a result of this new and unique approach, the synthetic response system 106 not only enables the near instantaneous generation of feedback in many instances, but also significantly lowers the real-world costs of acquiring feedback.

As illustrated by the foregoing discussion, the present disclosure utilizes a variety of terms to describe features and advantages of the synthetic response system 106. Additional detail is now provided regarding the meaning of such terms. For example, as used herein, the term “query” refers to a request for information. A query can take various forms that indicate the information requested to be provided in various implementations. For instance, a query can take the form of a directive, a statement, a question, or another form of request. Indeed, in some cases, a query includes a question—such as a survey question—to be answered via one or more responses to the query. In some cases, a query includes additional information, such as an audience segment or a target context to be used in responding to the query (e.g., to be used in generating informational responses to the query).

Additionally, as used herein, the term “informational response” refers to a response to a query. In particular, an informational response can refer to a response that includes information that is relevant to a query. Indeed, an informational response can include a response that includes information requested by a query. For instance, an informational response can include a response having an answer to a question indicated by a query. An informational response can include a response generated synthetically (e.g., via a large language model) or a response generated or otherwise formed based on user (i.e., human) interactions with a client device.

Further, as used herein, the term “respondent” refers to an entity associated with an informational response to a query. In particular, a respondent can refer to an entity that is reflected by an informational response. A respondent can indicate an entity that generates (or provides input for generating) the corresponding informational response or an entity for which an informational response is generated. Relatedly, as used herein, the term “synthetic respondent” refers to an artificial entity associated with an informational response. For example, a synthetic respondent can include a synthetic entity for which an informational response is generated (e.g., via a large language model). Additionally, as used herein, the term “human respondent” refers to a human associated with an informational response. For example, a human respondent can include a human (e.g., a user) that interacts with a client device to provide input used to form an informational response or can include a human for which an informational response is generated.

As used herein, the term “audience” refers to a group of respondents. In particular, an audience can refer to a group of one or more respondents for a query. In some instances, an audience refers to a group of respondents more generally in that a query is generally meant to solicit information from respondents, regardless of the nature of those respondents (e.g., whether the respondents are synthetic or human). In some cases, an audience includes a group of respondents more specifically in that a query is meant to solicit information from respondents of a particular nature. For instance, as used herein, the term “synthetic audience” refers to a group synthetic respondents. Similarly, as used herein, the term “human audience” refers to a group of human respondents. Thus, in some cases, an audience can include a synthetic audience, a human audience, or both. As suggested above, in some embodiments, an audience refers to a group of respondents from which a query is soliciting information. In certain cases, however, an audience more specifically includes those respondents associated with informational responses received and/or generated in response to a query. In particular, an audience can refer to the group of respondents reflected by the set of informational responses received and/or generated in response to a query.

Additionally, as used herein, the term “audience segment” refers to a targeted segment of an audience. In particular, an audience segment can refer to a segment of an audience targeted by a query for information. To illustrate, an audience segment can refer to a subset of all available respondents, where the respondents in the subset share one or more attributes or traits. In other words, an audience segment can refer to a segment of the general populace of available respondents where the segment is defined as a subset of respondents sharing one or more attributes or traits. As a non-limiting example, an audience segment can include a subset of respondents of the same age, within the same age range, of the same gender, living in the same location (e.g., the same country, state, province, or city), of the same status (e.g., customer or non-customer), or a combination thereof.

Further, as used herein, the term “constraint” refers to a guideline applied to the generation of one or more informational responses in response to a query. In particular, a constraint can refer to a limitation or requirement for the one or more informational responses. In some cases, a constraint includes information that is part of a query in addition to a question to be answered by one or more generated informational responses. To illustrate, a constraint can indicate one or more attributes that define an audience segment (e.g., an age range and/or a gender of respondents) or indicate a target context for generating informational responses.

As used herein, the term “target context” refers to a context associated with a query. In particular, a target context can refer to a context to be incorporated in one or more informational responses generated in response to a query. For example, in some cases, a target context includes an area of interest (e.g., an area of a market) that is targeted by a query. To illustrate, a target context can include a target industry, a target industry segment, a target use case, or a target brand.

As used herein, the term “machine learning model” refers to a computer-implemented model that is tunable (e.g., trainable) based on inputs to approximate unknown functions. In particular, a machine learning model can refer to a model that uses algorithms to learn from, and make predictions on, known data by analyzing the known data to learn to generate outputs that reflect patterns and attributes of the known data. For instance, in some cases, a machine learning model includes, but is not limited to, a neural network (e.g., a convolutional neural network, recurrent neural network, or other deep learning network), a decision tree (e.g., a gradient boosted decision tree), association rule learning, inductive logic programming, support vector learning, Bayesian network, regression-based model (e.g., censored regression), principal component analysis, or a combination thereof.

Additionally, as used herein, the term “neural network” refers to a model of interconnected artificial neurons (e.g., organized in layers) that communicate and learn to approximate complex functions and generate outputs based on inputs provided to the model. In particular, a neural network can refer to one or more machine learning algorithms. In some cases, a neural network includes an algorithm (or set of algorithms) that implements deep learning techniques that utilize a set of algorithms to model high-level abstractions in data. To illustrate, in some embodiments, a neural network includes a convolutional neural network, a recurrent neural network (e.g., a long short-term memory neural network), a generative adversarial network, a graph neural network, a multi-layer perceptron, or a diffusion neural network. In some embodiments, a neural network includes a combination of neural networks or neural network components.

Further, as used herein, the term “large language model” refers to a computer-implemented machine learning model trained to comprehend and generate human language text. In particular, a large language model can refer to a neural network (e.g., a deep neural network) with many parameters trained on large quantities of data (e.g., unlabeled text) using a particular learning technique (e.g., self-supervised learning). For example, in some cases, a large language model includes parameters trained to generate natural language text output from natural language text input. For instance, in certain instances, the synthetic response system 106 uses a large language model to generate natural language text output that provides informational responses to a natural language text input having a query (and one or more constraints). In some cases, a large language model implements a deep transformer neural network architecture. Some examples of large language models include, but are not limited to, chat generative pre-trained transformer (Chat GPT), Gemini, and Large Language Model Meta AI (LLaMA).

As used herein, the term “presentation” refers to a delivery of one or more informational responses generated and/or collected in response to a query. For instance, a presentation can refer to a delivery of an aggregation or summary of informational responses or can refer to a delivery of each individual informational response. A presentation can take the form of an audio deliver, a visual delivery, a textual delivery, or a combination thereof. To illustrate, a visual presentation can include a chart or graph of the informational responses generated and/or collected in response to a query.

Additionally, as used herein, the term “persona” refers to an identity or personality of an entity, such as a respondent. In particular, a persona can refer to one or more characteristics, personality traits, and/or other details of a respondent. For instance, in some cases, persona includes a narrative (e.g., a background) of a respondent. Further, in some instances, a persona includes one or more behaviors, preferences, and/or social connections of a respondent. In particular, in some cases, a persona can refer to the totality of preferences, behaviors, social connections, narrative elements, characteristics, and/or personality traits of a respondent. In some cases, the term “persona” is used interchangeably with the term “profile.” In some instances, however, a persona includes more than a profile. For instance, a persona of a respondent can incorporate a profile of that respondent plus additional information that is typically not included in a profile.

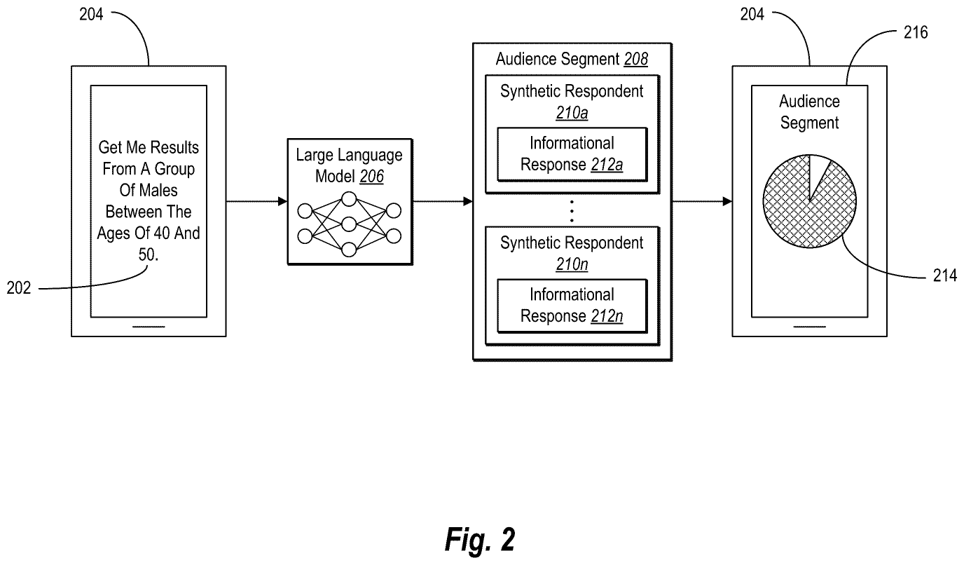

As previously mentioned, in one or more embodiments, the synthetic response system 106 generates one or more informational responses from an audience segment defined by a query. FIG. 2 illustrates the synthetic response system 106 generating one or more informational responses from an audience segment in accordance with one or more embodiments.

As shown in FIG. 2, the synthetic response system 106 receives constraints 202 (i.e., “males” and “between the ages of 40 and 50”) from a client device 204. In some cases, the constraints 202 are included as part of a query. For example, in some cases, the constraints 202 of FIG. 2 are part of the query 108 discussed with reference to FIG. 1. Indeed, the constraints 202 of FIG. 2 can include information in addition to the question (or directive or statement or other form of request) indicated by the query 108 of FIG. 1.

As further shown, the synthetic response system 106 provides the constraints 202 to a large language model 206. For example, the synthetic response system 106 can provide the constraints 202 as part of a prompt to the large language model 206. To illustrate, in some embodiments, the synthetic response system 106 generates a prompt from the constraints 202 (e.g., from the query that includes the constraints 202) and provides the prompt to the large language model 206.

Additionally, as illustrated in FIG. 2, the synthetic response system 106 determines (e.g., via the large language model 206) an audience segment 208 defined by the constraints 202. In particular, the synthetic response system 106 determines to use the audience segment 208 to respond to the query based on the constraints 202.

More particularly, the synthetic response system 106 can determine that the audience segment 208 includes synthetic respondents 210a-210n that satisfy the constraints 202. For instance, as the constraints 202 includes a combination of two separate constraints, the synthetic response system 106 determines that each of the synthetic respondents 210a-210n satisfy both constraints (e.g., each synthetic respondent has traits, characteristics, or a background that satisfy both constraints). Though FIG. 2 illustrates the constraints being used as a combination, in some cases, the synthetic response system 106 receives and implements constraints as alternatives (e.g., the query indicates that respondents must satisfy a first constraint or a second constraint). Indeed, in various implementations, the synthetic response system 106 receives and implements various numbers of constraints in various mixtures (e.g., a set of constraints where a first subset of constraints are required and a second subset of constraints are optional alternatives or a set of constraints having a first and second subset of constraints where each subset includes a plurality of constraints that are required when that subset is used but the subsets themselves are alternatives).

As illustrated in FIG. 2, the synthetic response system 106 generates informational responses 212a-212n from the synthetic respondents 210a-210n of the audience segment 208. In particular, the synthetic response system 106 uses the large language model 206 to generate the informational responses 212a-212n. As previously mentioned, in some cases, the synthetic response system 106 uses the large language model 206 to generate the synthetic respondents 210a-210n (e.g., personas or profiles for the synthetic respondents 210a-210n) and uses the synthetic respondents 210a-210n to further generate the informational responses 212a-212n. As further suggested, however, the synthetic response system 106 uses the large language model 206 to generate the informational responses 212a-212n to reflect the synthetic respondents 210a-210n without expressly generating the synthetic respondents 210a-210n.

By generating the informational responses 212a-212n from the synthetic respondents 210a-210n of the audience segment 208, the synthetic response system 106 generates informational response in accordance with the constraints 202. In particular, the synthetic response system 106 generates informational responses that reflect the preferences, behaviors, backgrounds, and/or personality traits of the group of respondents targeted by the constraints 202. Thus, the synthetic response system 106 enables a query to indicate a particular group of respondents that are to respond to a query, and the synthetic response system 106 generates informational responses from synthetic respondents of that group accordingly.

As further shown, the synthetic response system 106 generates and provides presentation 214 for display on a graphical user interface 216 of the client device 204 based on the informational responses 212a-212n. Thus, the synthetic response system 106 can provide query results that satisfy a request for information indicated by a query using a group of synthetic respondents that satisfy the constraints 202 of the query.

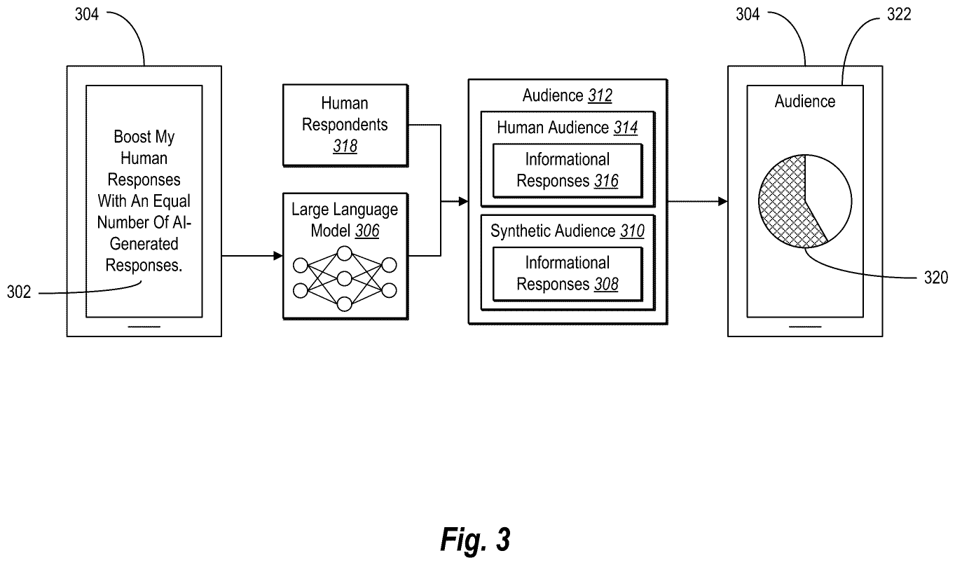

As discussed above, the synthetic response system 106 can use informational responses generated from a synthetic audience to supplement informational responses collected from a human audience. FIG. 3 illustrates the synthetic response system 106 using a synthetic audience to supplement a human audience in accordance with one or more embodiments.

As shown in FIG. 3, the synthetic response system 106 receives, from a client device 304, instructions 302 to use synthetic respondents to support human respondents. In particular, the instructions 302 request the synthetic response system 106 to generate informational responses from synthetic respondents to supplement other informational responses collected from human respondents (e.g., users interacting with a client device to provide input for the other informational responses). In some cases, the instructions 302 are included as part of a query. For example, in some cases, the instructions 302 of FIG. 3 are part of the query 108 discussed with reference to FIG. 1. Indeed, the instructions 302 of FIG. 3 can include information in addition to the question indicated by the query 108 of FIG. 1.

In one or more embodiments, the synthetic response system 106 receives the query containing the instructions 302 as part of a campaign designed to obtain informational responses from both synthetic and human respondents. In some embodiments, the synthetic response system 106 receives the query with the instructions 302 after a campaign targeting human respondents fails to collect a sufficient number of informational responses from such respondents (e.g., the number of informational responses that were collected is not enough to derive a supported conclusion). In some cases, the synthetic response system 106 receives the query with the instructions 302 after a campaign targeting human respondents runs out of resources needed to obtain additional informational responses from human respondents.

As indicated by FIG. 3, the instructions 302 can indicate a number of informational responses to be generated from synthetic respondents. In particular, the instructions 302 of FIG. 3 indicate that a number of informational responses from synthetic respondents that is equal to a number of informational responses collected from human respondents is to be generated. Any number of informational responses, however, can be requested by the instructions 302.

As further shown in FIG. 3, the synthetic response system 106 provides the instructions 302 to a large language model 306. For example, the synthetic response system 106 can provide the instructions 302 as part of a prompt to the large language model 306. To illustrate, in some embodiments, the synthetic response system 106 generates a prompt from the instructions 302 (e.g., from the query that includes the instructions 302) and provides the prompt to the large language model 306.

As illustrated, the synthetic response system 106 uses the large language model 306 to generate informational responses 308 from a synthetic audience 310. In particular, the synthetic response system 106 uses the large language model 306 to generate the informational responses 308 from synthetic respondents of the synthetic audience 310.

As further illustrated, the synthetic response system 106 uses the synthetic audience 310 as part of an audience 312. In particular, the synthetic response system 106 uses the synthetic audience 310 as one component of the audience 312. Indeed, as shown in FIG. 3, in addition to the synthetic audience 310, the audience 312 includes a human audience 314. Further, the synthetic response system 106 obtains informational responses 316 from the human audience 314. In particular, the synthetic response system 106 obtains the informational responses 316 from human respondents 318 of the human audience 314.

Indeed, as mentioned, the instructions 302 indicate that informational responses from both synthetic respondents and human respondents are to be used in response to the query. Thus, the synthetic response system 106 determines to retrieve or otherwise collect the informational responses 316 from the human respondents 318. For instance, in some cases, the synthetic response system 106 provides a query similar to the query containing the instructions 302 (e.g., a query having the same question to be answered) to client devices associated with the human respondents 318. The synthetic response system 106 further receives the informational responses 316 from the client devices or otherwise receives user input that the synthetic response system 106 uses to create the informational responses 316. As shown in FIG. 3, in addition to collecting the informational responses 316 from the human respondents 318 the synthetic response system 106 uses the large language model 306 to generate the informational responses 308 from the synthetic respondents.

As further shown in FIG. 3, the generates and provides a presentation 320 for display within a graphical user interface 322 of the client device 304. As indicated, the presentation 320 represents query results from the audience 312 as a whole. In particular, the presentation 320 represents the informational responses 308 generated from the synthetic audience 310 and the informational responses 316 collected or generated from the human audience 314.

In some embodiments, the synthetic response system 106 provides further interactivity through the graphical user interface 322. For instance, the synthetic response system 106 can provide one or more selectable options for viewing results from a particular audience (e.g., the synthetic audience 310 or the human audience 314). Additionally, the synthetic response system 106 can provide one or more selectable options for viewing the balance of respondents among the different informational responses (e.g., how many human respondents and synthetic respondents are associated with a particular response).

Thus, the synthetic response system 106 can use responses generated via artificial intelligence in combination with responses collected from human respondents to determine the answers requested by a query.

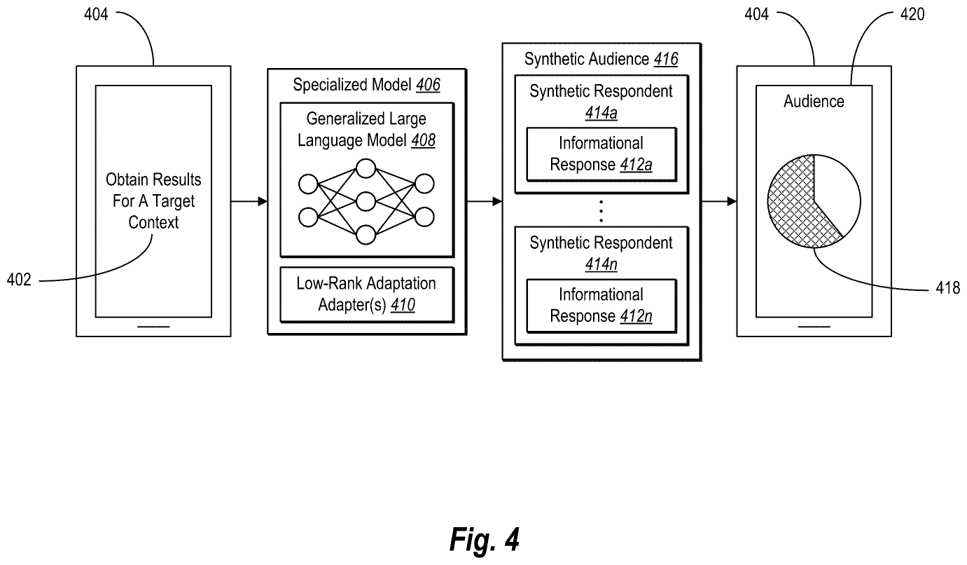

As further discussed above, the synthetic response system 106 can generate informational responses from synthetic respondents for a target context. FIG. 4 illustrates the synthetic response system 106 generating informational responses for a target context in accordance with one or more embodiments.

As shown in FIG. 4, the synthetic response system 106 receives an indication 402 of a target context from a client device 404. In some cases, the indication 402 is included as part of a query. For example, in some cases, the indication 402 of FIG. 4 is part of the query 108 discussed with reference to FIG. 1. Indeed, the indication 402 of FIG. 4 can include information in addition to the question indicated by the query 108 of FIG. 1.

As further shown, the synthetic response system 106 provides the indication 402 to a specialized model 406. For example, the synthetic response system 106 can provide the indication 402 as part of a prompt to the specialized model 406. To illustrate, in some embodiments, the synthetic response system 106 generates a prompt from the indication 402 (e.g., from the query that includes the indication 402) and provides the prompt to the specialized model 406.

As used herein, the term “specialized model” refers to a computer-implemented model that has been specifically configured to respond to queries for a target context. In particular, a specialized model can refer to a computer-implemented model that has been fine tuned to generate informational responses for a target context. To illustrate, in some cases, a specialized model includes a computer-implemented model—such as a large language model or other neural network—having at least a subset of parameters learned for a target context. As shown in FIG. 4, the specialized model 406 includes a generalized large language model 408 and one or more low-rank adaptation (LoRA) adapters 410.

As used herein, the term “generalized large language model” refers to a large language model configured to generate generalized informational responses. In particular, a generalized large language model can refer to a large language model configured to generate informational responses for a general context (e.g., to generate informational response that do not target a particular context). For instance, in some cases, a generalized large language model includes a large language model trained on a generalized set of training data (e.g., training data associated with a general context). Thus, a generalized large language model can include parameters that have been learned to generate informational responses without targeting a particular context.

Additionally, as used herein, the term “low-rank adaptation adapter” (or “LoRA adapter”) refers to a light-weight machine learning component used for fine-tuning a larger pre-trained machine learning model. In particular, a low-rank adaptation adapter can refer to a machine learning component used to fine tune a pre-trained large language model, such as a pre-trained generalized large language model. To illustrate, a low-rank adaptation adapter can include a machine learning component that has a set of weights that are learned (e.g., during a training or fine-tuning process) to adapt a pre-trained large language model to a particular context. In many cases, a low-rank adaptation adapter can adapt the pre-trained large language model to the particular context without modifying the weights of the large language model.

Thus, in one or more embodiments, the synthetic response system 106 trains the generalized large language model 408 using a general set of training data. The synthetic response system 106 can further train the LoRA adapters 410 on a set of training data associated with a target context (e.g., the context to be targeted during implementation). The synthetic response system 106 can train the LoRA adapters 410 separately or with the generalized large language model 408. For instance, the synthetic response system 106 can freeze the parameters of the generalized large language model 408 and train the LoRA adapters 410 with the generalized large language model 408 to fine tune the generalized large language model 408 via the LoRA adapters 410. In other words, the synthetic response system 106 can train the LoRA adapters 410 with the generalized large language model 408 to learn parameters for the LoRA adapters 410 that work with the parameters of the generalized large language model 408 to generate informational responses for the target context.

As shown in FIG. 4, the synthetic response system 106 uses the specialized model 406 to generate informational responses 412a-412n from synthetic respondents 414a-414n of a synthetic audience 416. In particular, the synthetic response system 106 uses the specialized model 406 to generate informational responses 412a-412n for the target context. As further shown, the synthetic response system 106 generates and provides a presentation 418 for display within a graphical user interface 420 of the client device 404.

Thus, the synthetic response system 106 can configure a large language model to target a particular context when generating informational responses from a synthetic audience. Further, the synthetic response system 106 can generate informational responses for a target context using a generalized large language model that can be further configured for alternative target contexts. To illustrate, the synthetic response system 106 can configure the generalized large language model for a first target context using a first set of LoRA adapters having parameters learned for the first target context. The synthetic response system 106 can further configure the generalized large language model for a second target context using a second set of LoRA adapters having parameters learned for the second target context. In some instances, by using LoRA adapters having parameters for each target context, the synthetic response system 106 can quickly switch between the first and second target contexts without having to update the parameters of the generalized large language model.

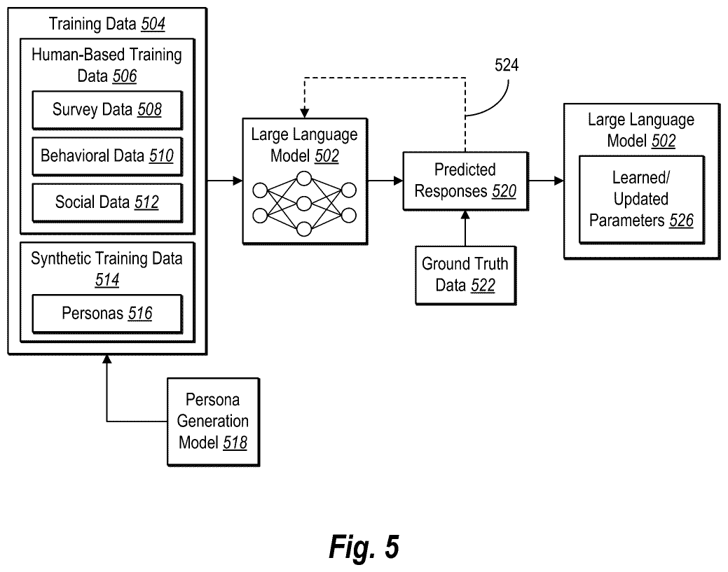

As previously mentioned, in one or more embodiments, the synthetic response system 106 trains a large language model to generate informational responses from synthetic respondents. FIG. 5 illustrates the synthetic response system 106 training a large language model in accordance with one or more embodiments.

As shown in FIG. 5, the synthetic response system 106 trains a large language model 502 using training data 504. As further shown, the training data 504 includes human-based training data 506. As used herein, the term “human-based training data” refers to training data associated with human entities. In particular, human-based training data can refer to training data associated with real-world human entities. For instance, in some cases, human-based training data includes training data determined based on the activity of human entities. In particular, human-based training data can include training data determined based on human interactions with one or more digital systems (where the humans are referred to as “users” of the digital system(s)). For example, as shown in FIG. 5, the human-based training data 506 can include survey data 508 (e.g., responses to one or more electronic surveys), behavioral data 510 (e.g., interactions with an e-commerce site, a streaming service, a news provider, and/or a system that provides recommendations), and social data 512 (e.g., social network connections, posts on a social networking site, and/or comments or other interactions with other posts on a social networking site).

In one or more embodiments, the human-based training data 506 corresponds to personas (or profiles) of the human entities represented therein. For instance, the human-based training data 506 can include, for each human entity represented therein, one or more survey data points, one or more behavioral data points, one or more social data points, and/or one or more other relevant data points that would be included in a persona or profile.

Additionally, as shown in FIG. 5, the synthetic response system 106 includes synthetic training data 514. As used herein, the term “synthetic training data” refers to training data that is synthetically created. In particular, synthetic training data can refer to training data that is generated for the training of a large language model. For instance, in some cases, synthetic training data includes training data that is generated as a synthetic representation of human entities.

For instance, as shown in FIG. 5, the synthetic training data 514 includes personas 516. The personas 516 can include personas that correspond to synthetic respondents. In particular, each persona can correspond to a different synthetic respondent.

As illustrated, the synthetic response system 106 can use a persona generation model 518 to generate the personas 516 for inclusion in the synthetic training data 514. As used herein, the term “persona generation model” refers to a computer-implemented model that generates personas. In particular, a persona generation model can refer to a computer-implemented model that generates personas for inclusion within training data. For instance, in some cases, a persona generation model includes a machine learning model, such as a neural network. To illustrate, in some instances, a persona generation model includes a large language model. Thus, in some cases, the synthetic response system 106 provides a prompt to the persona generation model 518 (e.g., a prompt indicating a number of personas to generate and/or some attributes to incorporate within the personas) and uses the persona generation model 518 to generate the personas 516 in accordance with the prompt.

Though FIG. 5 illustrates the personas 516 as the only component of the synthetic training data 514, the synthetic training data 514 can include other components in various implementations. For instance, the synthetic training data 514 can include separate synthetic survey data, behavioral data, and/or social data. Indeed, while a persona, in many cases, represents a combination of various attributes (e.g., a combination of survey data, behavioral data, social data, and/or other data), the synthetic response system 106 can use other pieces of information separately from the personas 516 in some cases.

In one or more embodiments, the synthetic response system 106 uses human-based data (e.g., human-based survey data, behavioral data, social data, and/or other data) to generate the synthetic training data 514. For instance, in some embodiments, the synthetic response system 106 uses the human-based data to generate the personas 516. To illustrate, in some cases, the synthetic response system 106 configures the persona generation model 518 to mix the human-based data corresponding to one human entity with the human-based data corresponding to one or more other human entities to create one or more new personas. In some cases, the synthetic response system 106 uses the human-based training data 506 to generate the personas 516.

As shown in FIG. 5, the synthetic response system 106 uses the large language model 502 to generate predicted responses 520 based on the training data 504. The predicted responses 520 can include informational responses generated in response to training queries based on the training data 504. Each predicted response generated via the large language model 502 can reflect the training data 504. In particular, each predicted response can reflect data from the human-based training data 506 or data from the synthetic training data 514. For instance, each predicted response can reflect a persona represented in the human-based training data 506 or a persona represented in the synthetic training data 514.

As further shown in FIG. 5, the synthetic response system 106 compares the predicted responses 520 with corresponding ground truth data 522 (e.g., via one or more loss functions) and back propagates the determined error to the large language model 502 (as indicated by the dashed arrow 524). In doing so, the synthetic response system 106 modifies parameters of the large language model 502. Over multiple iterations, the synthetic response system 106 learns or updates parameters 526 that enable the large language model 502 to generate informational responses from synthetic respondents.

Indeed, as indicated in FIG. 5, in some cases, the synthetic response system 106 trains the large language model 502 by learning the model parameters from an initialized state. In some instances, however, the large language model 502 is pre-trained (e.g., the parameters have already been learned), and the synthetic response system 106 fine tunes the large language model 502 by updating the parameters. For instance, in some cases, the synthetic response system 106 gains access to additional training data that better enables the large language model 502 to generate informational responses or that enables the large language model 502 to generate informational responses for new contexts. In some cases, the synthetic response system 106 determines that the performance of the large language model 502 is unsatisfactory and uses the additional training data to adjust the performance.

By learning or updating parameters for a large language model using synthetic training data that includes personas, the synthetic response system 106 trains or fine tunes the large language model to generate informational responses that reflect those personas. In particular, the synthetic response system 106 can train or fine tune the large language model to generate each informational response to reflect a corresponding persona. Thus, at inference time, the synthetic response system 106 can use the large language model to generate a set of informational responses that reflect the personas of a set of synthetic respondents. In particular, each informational response in the set can reflect a persona of a different synthetic respondent such that the set of informational responses represents a variety of personas.

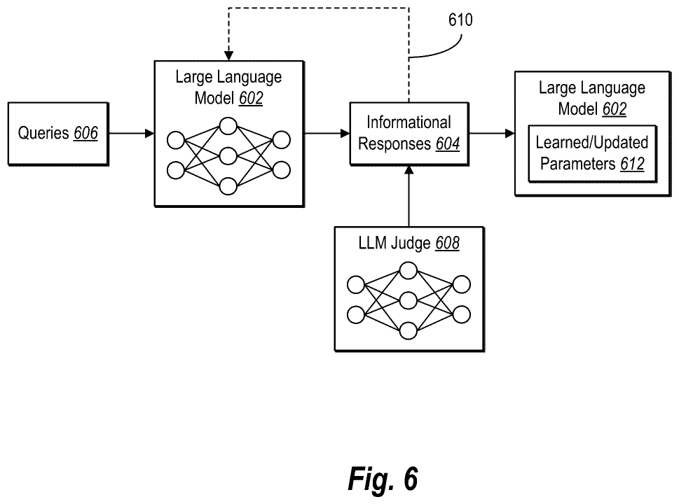

As just suggested, the synthetic response system 106 can evaluate the performance of a large language model in generating informational responses in response to queries. Based on the evaluations, the synthetic response system 106 can modify the parameters of the large language model. FIG. 6 illustrates the synthetic response system 106 evaluating the performance of a large language model in accordance with one or more embodiments.

As shown in FIG. 6, the synthetic response system 106 uses a large language model 602 to generate informational responses 604 in response to queries 606. As further shown, the synthetic response system 106 uses an additional large language model 608 (referred to as the “LLM Judge”) to evaluate the informational responses 604. For instance, the synthetic response system 106 can use the additional large language model 608 to determine whether the informational responses 604 include appropriate responses to the queries 606.

To illustrate, the synthetic response system 106 can use the additional large language model 608 to determine whether a given informational response provides an answer to a question of a corresponding query. In some cases, the synthetic response system 106 uses the additional large language model 608 to determine whether the given informational response provides a relevant answer (e.g., provides information that useful in determining query results). In one or more embodiments, the synthetic response system 106 uses the additional large language model 608 to provide a score for the informational response, where the score indicates the quality of the informational response.

As shown in FIG. 6, the synthetic response system 106 modifies parameters of the large language model 602 (as indicated by the dashed arrow 610) based on the evaluations of the additional large language model 608. For instance, the synthetic response system 106 can modify the parameters of the large language model 602 based on scores generated for the informational responses 604 by the additional large language model 608. Thus, the synthetic response system 106 learns or updates parameters 612 that enable the large language model 602 to generate informational responses from synthetic respondents.

Indeed, as indicated by FIG. 6, the synthetic response system 106 can use the additional large language model 608 to evaluate informational responses generated by the large language model 602 at inference time. Thus, the synthetic response system 106 can use the additional large language model 608 to determine whether the large language model 602 is performing satisfactorily when responding to queries received from client devices and update the parameters of the large language model 602 as needed. In some embodiments, the synthetic response system 106 uses the additional large language model 608 to train the large language model 602 by learning the model parameters from an initialized state.

In one or more embodiments, the synthetic response system 106 trains the additional large language model 608 to evaluate informational responses via one or more reinforcement learning techniques. In some cases, the synthetic response system 106 trains the additional large language model 608 using one or more contrastive learning techniques. For example, the synthetic response system 106 can use human annotations of training data that indicate whether outputs resulting from that training data is high quality or low quality. For instance, the synthetic response system 106 can use human annotations for panel data and/or synthetic surveys (e.g., informational responses generated via a large language model). The synthetic response system 106 can use the human annotations to configure the parameters of the additional large language model 608.

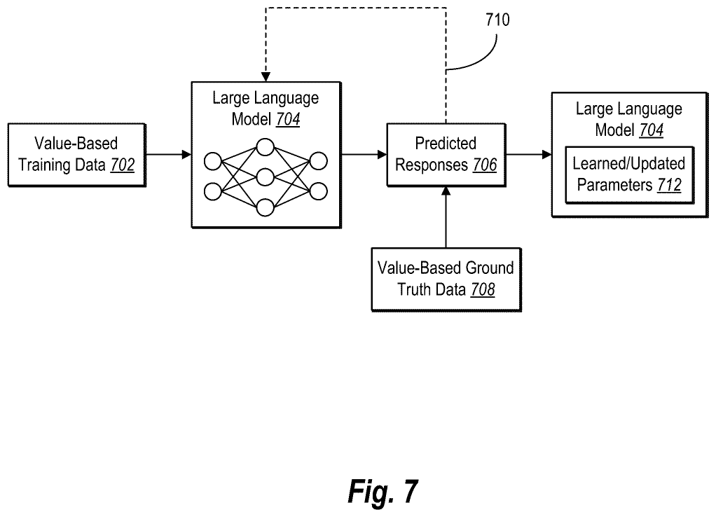

As discussed above, in some cases, the synthetic response system 106 configures a large language model to generate informational responses that reflect or adhere to a particular set of standards. FIG. 7 illustrates the synthetic response system 106 configuring a machine learning model to adhere to a set of standards in accordance with one or more embodiments.

For instance, as shown in FIG. 7, the synthetic response system 106 uses value-based training data 702. As used herein, the term “value-based training data” refers to training data that aligns with one or more standards. In particular, value-based training data can include a set of training data where each data point aligns with one or more standards. For instance, value-based training data can omit data points that conflict with a set of standards (e.g., data points having undesired language) and/or include data points that promote or require adherence to the set of standards (e.g., data points that include desired language). The standards reflected by value-based training data can vary in various embodiments and can be configurable via user input in many instances. Further, the standards can include ethical standards, industry standards, campaign-specific standards, or the standards of a particular entity (e.g., a business or other organization).

As illustrated in FIG. 7, the synthetic response system 106 can use a large language model 704 to generate predicted responses 706 from the value-based training data 702. The synthetic response system 106 can further compare the predicted responses 706 to corresponding value-based ground truth data 708 and modify parameters of the large language model 704 based on the comparisons (as indicated by the dashed arrow 710). Thus, the synthetic response system 106 learns or updates parameters 712 that enable the large language model 704 to generate informational responses from synthetic respondents.

Though FIG. 7 illustrates a particular approach to configuring the large language model 704 to adhere to a set of standards, various approaches can be used in various embodiments. For instance, rather than (or in addition to) curating value-based training data for training the large language model 704, the synthetic response system 106 can use a filter that filters out predicted responses that conflict with the standards. Thus, the synthetic response system 106 only updates the model parameters using generated outputs that adhere to the standards. In some cases, the synthetic response system 106 uses such a filter at inference time so that only informational responses that adhere to the standards are presented to the client device that submitted the request. By implementing a filter at inference time, the synthetic response system 106 enables standards to be changed (e.g., by changing the filter that is applied) without the need to re-train the model.

In some cases, the synthetic response system 106 instills values into the generation process via one or more guardrails provided to the large language model 704. Indeed, as previously mentioned, the synthetic response system 106 can provide a query to a large language model as part of a prompt. In some cases, the synthetic response system 106 provides additional information within the prompt to ensure that the large language model 704 adheres to a set of standards when generating the informational responses. For instance, the synthetic response system 106 can include guardrails that prevent the large language model 704 from generating informational responses that conflict with the corresponding standards and/or include guardrails that promote or require the large language model 704 to generate informational response that adhere to the set of standards.

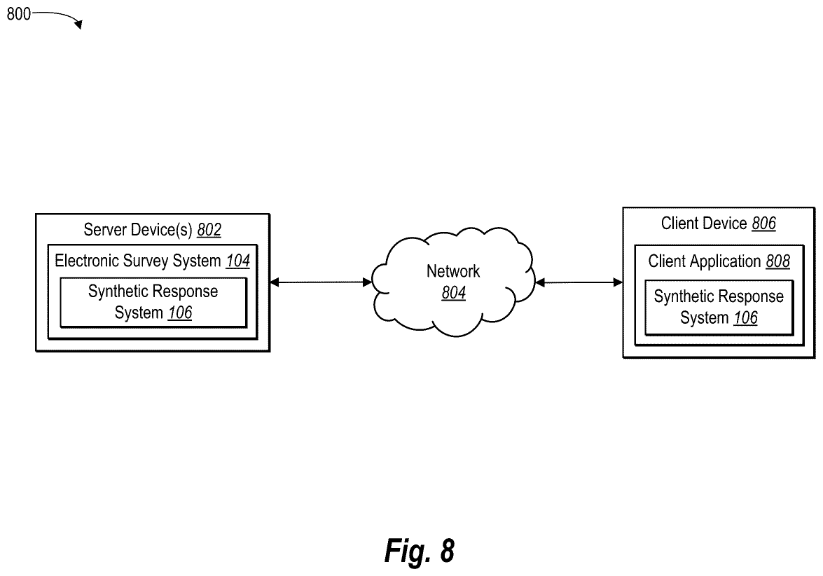

In one or more embodiments, the synthetic response system 106 operates within a computing environment. For example, FIG. 8 illustrates a schematic diagram of an exemplary system environment (“environment”) 800 in which a synthetic response system 106 operates. As illustrated in FIG. 8, the environment 800 includes a server device(s) 802, a network 804, and a client device 806.

Although the environment 800 of FIG. 8 is depicted as having a particular number of components, the environment 800 is capable of having any number of additional or alternative components (e.g., any number of server devices, client devices, or other components in communication with the synthetic response system 106 via the network 804). Similarly, although FIG. 8 illustrates a particular arrangement of the server device(s) 802, the network 804, and the client device 806, various additional arrangements are possible.

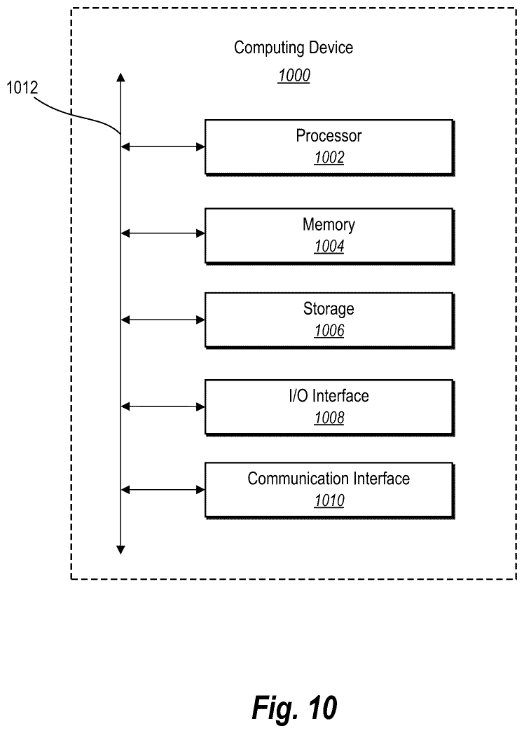

The server device(s) 802, the network 804, and the client device 806 are communicatively coupled with each other either directly or indirectly (e.g., through the network 804 discussed in greater detail below in relation to FIG. 10). Moreover, the server device(s) 802 and the client device 806 each include one of a variety of computing devices (including one or more computing devices as discussed in greater detail with relation to FIG. 10).

As mentioned above, the environment 800 includes the server device(s) 802. In one or more embodiments, the server device(s) 802 generates, stores, receives, and/or transmits data, including queries and informational response in response to queries. In one or more embodiments, the server device(s) 802 comprises a data server. In some implementations, the server device(s) 802 comprises a communication server or a web-hosting server.

As shown, the server device(s) 802 includes the electronic survey system 104. In one or more embodiments, the electronic survey system 104 provides functionality that facilitates the creation and distribution of electronic surveys and the collection and processing of survey responses. As previously mentioned, in some cases, the synthetic response system 106 operates as part of an experience management system that facilitates the collection and processing of data based on user interactions with digital systems.

Additionally, the server device(s) 802 include the synthetic response system 106. As discussed above, the synthetic response system 106 can respond to queries by generating informational responses from a synthetic audience. For instance, the synthetic response system 106 can use a large language model to generate informational responses from synthetic respondents in response to a query. The synthetic response system 106 can further provide a presentation regarding the query results.

In one or more embodiments, the client device 806 includes a computing device that can generate, access, edit, implement, modify, store, and/or provide, for display, digital content, such as queries, informational responses, and corresponding presentations. For example, the client device 806 can include a smartphone, tablet, desktop computer, laptop computer, head-mounted-display device, or other electronic device. The client device 806 can include one or more applications (e.g., the client application 808) that can access, edit, implement, modify, store, and/or provide, for display, digital content, such as queries, informational responses, and corresponding presentations. For example, in some embodiments, the client application 808 includes a software application installed on the client device 806. In other cases, however, the client application 808 includes a web browser or other application that accesses a software application hosted on the server device(s) 802.

The synthetic response system 106 can be implemented in whole, or in part, by the individual elements of the environment 800. Indeed, as shown in FIG. 8 the synthetic response system 106 can be implemented with regard to the server device(s) 802 and/or at the client device 806. In particular embodiments, the synthetic response system 106 on the client device 806 comprises a web application, a native application installed on the client device 806 (e.g., a mobile application, a desktop application, a plug-in application, etc.), or a cloud-based application where part of the functionality is performed by the server device(s) 802.

In additional or alternative embodiments, the synthetic response system 106 on the client device 806 represents and/or provides the same or similar functionality as described herein in connection with the synthetic response system 106 on the server device(s) 802. In some implementations, the synthetic response system 106 on the server device(s) 802 supports the synthetic response system 106 on the client device 806.

In some embodiments, the synthetic response system 106 includes a web hosting application that allows the client device 806 to interact with content and services hosted on the server device(s) 802. To illustrate, in one or more implementations, the client device 806 accesses a web page or computing application supported by the server device(s) 802. The client device 806 provides input to the server device(s) 802, such as a query. In response, the synthetic response system 106 on the server device(s) 802 utilizes a large language model to generate one or more informational responses from a synthetic audience. The server device(s) 802 then provides the informational responses to the client device 806.

In some embodiments, though not illustrated in FIG. 8, the environment 800 has a different arrangement of components and/or has a different number or set of components altogether. For example, in certain embodiments, the client device 806 communicates directly with the server device(s) 802 bypassing the network 804.

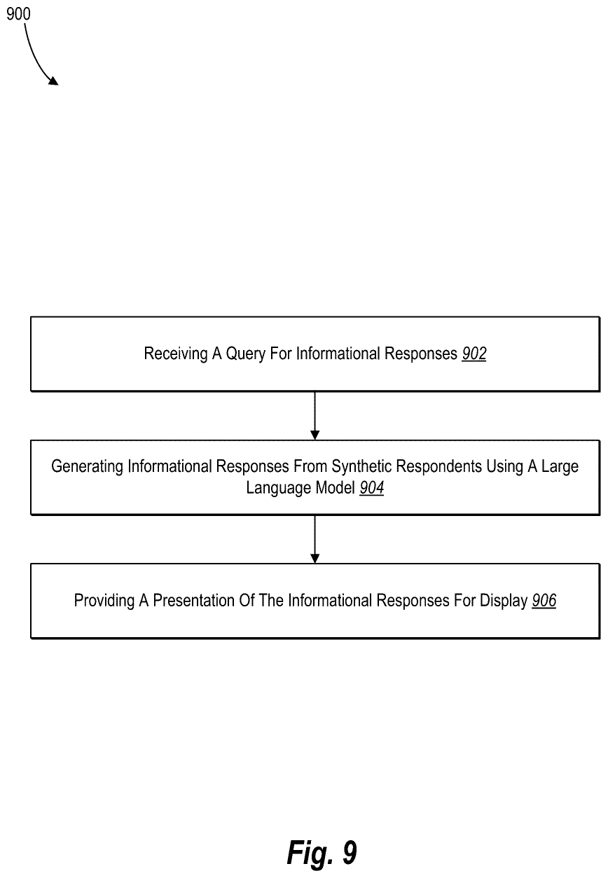

FIGS. 1-8, the corresponding text, and the examples provide a number of different methods, systems, devices, and non-transitory computer-readable media of the synthetic response system 106. In addition to the foregoing, one or more embodiments can also be described in terms of flowcharts comprising acts for accomplishing the particular result, as shown in FIG. 9. FIG. 9 may be performed with more or fewer acts. Further, the acts may be performed in different orders. Additionally, the acts described herein may be repeated or performed in parallel with one another or in parallel with different instances of the same or similar acts.

FIG. 9 illustrates a flowchart of a series of acts 900 for responding to a query using a synthetic audience in accordance with one or more embodiments. FIG. 9 illustrates acts according to one embodiment, alternative embodiments may omit, add to, reorder, and/or modify any of the acts shown in FIG. 9. In some implementations, the acts of FIG. 9 are performed as part of a method. Alternatively, a non-transitory computer-readable medium can store instructions thereon that, when executed by at least one processor, cause a computer device to perform the acts of FIG. 9. In some embodiments, a system performs the acts of FIG. 9. For example, in one or more embodiments, a system includes at least one processor and at least one non-transitory computer-readable medium storing instructions that, when executed by the at least one processor, cause the system to perform the acts of FIG. 9.

The series of acts 900 includes an act 902 for receiving a query for informational responses. For example, the act 902 can involve receiving, from a client device, a query for informational responses from an audience of respondents.

The series of acts 900 also includes an act 904 for generating informational responses from synthetic respondents using a large language model. For instance, the act 904 can involve generating, using a large language model and in response to the query, a set of informational responses from a set of synthetic respondents.

Further, the series of acts 900 includes an act 906 for providing a presentation of the informational responses for display. To illustrate, the act 906 can involve providing, for display on the client device, a presentation of the set of informational responses from the set of synthetic respondents.

In one or more embodiments, the synthetic response system 106 further collects an additional set of informational responses from a set of client devices associated with human respondents. As such, in some cases, providing the presentation of the set of informational responses from the set of synthetic respondents comprises providing the presentation of the set of informational responses from the set of synthetic respondents and the additional set of informational responses from the set of client devices associated with the human respondents.

In some embodiments, receiving the query for the informational responses from the audience of respondents comprises receiving the query for the informational responses for a target context that includes at least one of a target industry, a target industry segment, a target use case, or a target brand; and generating the set of informational responses from the set of synthetic respondents using the large language model comprises generating the set of informational responses from the set of synthetic respondents using a general population large language model and one or more low-rank adaptation adapters that adapt the general population large language model to the target context. In some cases, receiving the query for the informational responses from the audience of respondents comprises receiving one or more constraints that define an audience segment; and generating, using the large language model, the set of informational responses from the set of synthetic respondents comprises generating, using the large language model, the set of informational responses from a plurality of synthetic respondents from the audience segment.

In certain embodiments, the synthetic response system 106 further learns parameters for the large language model using value-based training data that aligns with a set of standards for generating informational responses. Accordingly, in some cases, generating, using the large language model in response to the query, the set of informational responses comprises generating, using the large language model in response to the query, the set of informational responses to adhere to the set of standards reflected by the value-based training data. In some instances, the synthetic response system 106 further generates, using a persona generation model, a plurality of personas for a plurality of synthetic respondents; and learns parameters for the large language model using training data that includes ground truth data reflective of predicted responses to training queries from the plurality of personas. Thus, in some implementations, generating, using the large language model, the set of informational responses from the set of synthetic respondents comprises generating, using the large language model, at least one informational response from at least one synthetic respondent having a persona from the plurality of personas.

In one or more embodiments, the synthetic response system 106 further updates parameters of the large language model using human-based training data that includes at least one of survey data, behavioral data, or social data. Additionally, in some embodiments, the synthetic response system 106 further determines, using an additional machine learning model, evaluations for the informational responses from the set of synthetic respondents generated by the large language model; and updates parameters of the large language model based on the evaluations.

Embodiments of the present disclosure can comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein can be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions can be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure can be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure can also be practiced in distributed system environments where local and remote computer systems, which are linked (either by hardwired data links, wireless data links, or by a combination of hardwired and wireless data links) through a network, both perform tasks. In a distributed system environment, program modules can be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates a block diagram of computing device 1000 that can be configured to perform one or more of the processes described above. One will appreciate that one or more computing devices, such as the computing device 1000, can implement the various devices of the environment of FIG. 8. As shown by FIG. 10, the computing device 1000 can comprise a processor 1002, a memory 1004, a storage device 1006, an I/O interface 1008, and a communication interface 1010, which can be communicatively coupled by way of a communication infrastructure 1012. While a computing device 1000 is shown in FIG. 10, the components illustrated in FIG. 10 are not intended to be limiting. Additional or alternative components can be used in other embodiments. Furthermore, in certain embodiments, the computing device 1000 can include fewer components than those shown in FIG. 10. Components of the computing device 1000 shown in FIG. 10 will now be described in additional detail.

In one or more embodiments, the processor 1002 includes hardware for executing instructions, such as those making up a computer program. As an example, and not by way of limitation, to execute instructions, the processor 1002 can retrieve (or fetch) the instructions from an internal register, an internal cache, the memory 1004, or the storage device 1006 and decode and execute them. In one or more embodiments, the processor 1002 can include one or more internal caches for data, instructions, or addresses. As an example, and not by way of limitation, the processor 1002 can include one or more instruction caches, one or more data caches, and one or more translation lookaside buffers (TLBs). Instructions in the instruction caches can be copies of instructions in the memory 1004 or the storage device 1006.

The memory 1004 can be used for storing data, metadata, and programs for execution by the processor(s). The memory 1004 can include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1004 can be internal or distributed memory.

The storage device 1006 includes storage for storing data or instructions. As an example, and not by way of limitation, storage device 1006 can comprise a non-transitory storage medium described above. The storage device 1006 can include a hard disk drive (HDD), a floppy disk drive, flash memory, an optical disc, a magneto-optical disc, magnetic tape, or a Universal Serial Bus (USB) drive or a combination of two or more of these. The storage device 1006 can include removable or non-removable (or fixed) media, where appropriate. The storage device 1006 can be internal or external to the computing device 1000. In one or more embodiments, the storage device 1006 is non-volatile, solid-state memory. In other embodiments, the storage device 1006 includes read-only memory (ROM). Where appropriate, this ROM can be mask programmed ROM, programmable ROM (PROM), erasable PROM (EPROM), electrically erasable PROM (EEPROM), electrically alterable ROM (EAROM), or flash memory or a combination of two or more of these.

The I/O interface 1008 allows a user to provide input to, receive output from, and otherwise transfer data to and receive data from computing device 1000. The I/O interface 1008 can include a mouse, a keypad or a keyboard, a touch screen, a camera, an optical scanner, network interface, modem, other known I/O devices or a combination of such I/O interfaces. The I/O interface 1008 can include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 1008 is configured to provide graphical data to a display for presentation to a user. The graphical data can be representative of one or more graphical user interfaces and/or any other graphical content as can serve a particular implementation.

The communication interface 1010 can include hardware, software, or both. In any event, the communication interface 1010 can provide one or more interfaces for communication (such as, for example, packet-based communication) between the computing device 1000 and one or more other computing devices or networks. As an example, and not by way of limitation, the communication interface 1010 can include a network interface controller (NIC) or network adapter for communicating with an Ethernet or other wire-based network or a wireless NIC (WNIC) or wireless adapter for communicating with a wireless network, such as a WI-FI.

Additionally, or alternatively, the communication interface 1010 can facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks can be wired or wireless. As an example, the communication interface 1010 can facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, the communication interface 1010 can facilitate communications various communication protocols. Examples of communication protocols that can be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 1012 can include hardware, software, or both that couples components of the computing device 1000 to each other. As an example and not by way of limitation, the communication infrastructure 1012 can include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

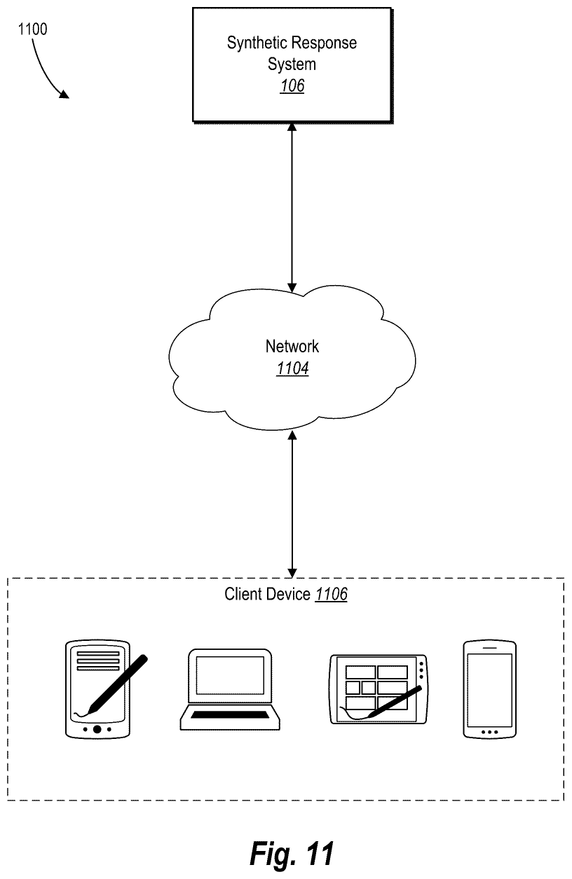

FIG. 11 illustrates an example network environment 1100 of an synthetic response system 106, such as embodiments of the synthetic response system 106 described herein. The network environment 1100 includes the synthetic response system 106 and a client device 1106 connected to each other by a network 1104. Although FIG. 11 illustrates a particular arrangement of the synthetic response system 106, the client device 1106, and the network 1104, one will appreciate that other arrangements of the network environment 1100 are possible. For example, a client device of the client device 1106 is directly connected to the synthetic response system 106. Moreover, this disclosure contemplates any suitable number of client systems, synthetic response systems, and networks are possible. For instance, the network environment 1100 includes multiple client systems.

This disclosure contemplates any suitable network. As an example, one or more portions of the network 1104 may include an ad hoc network, an intranet, an extranet, a VPN, a LAN, a wireless LAN, a WAN, a wireless WAN, a MAN, a portion of the Internet, a portion of the Public Switched Telephone Network (PSTN), a cellular telephone network, a safelight network, or a combination of two or more of these. The term “network” may include one or more networks and may employ a variety of physical and virtual links to connect multiple networks together.

In particular embodiments, the client device 1106 is an electronic device including hardware, software, or embedded logic components or a combination of two or more such components and capable of carrying out the appropriate functionalities implemented or supported by the client system. As an example, the client device 1106 includes any of the computing devices discussed above. The client device 1106 may enable a user at the client device 1106 to access the network 1104. Further, the client device 1106 may enable a user to communicate with other users at other client systems.

In some embodiments, the client device 1106 may include a web browser and may have one or more add-ons, plug-ins, or other extensions. The client device 1106 may render a web page based on the HTML files from the server for presentation to the user. For example, the client device 1106 renders the graphical user interface described above.

In one or more embodiments, the synthetic response system 106 includes a variety of servers, sub-systems, programs, modules, logs, and data stores. In some embodiments, the synthetic response system 106 includes one or more of the following: a web server, action logger, API-request server, relevance-and-ranking engine, content-object classifier, notification controller, action log, third-party-content-object-exposure log, inference module, authorization/privacy server, search module, user-targeting module, user-interface module, user-profile store, connection store, third-party content store, or location store. The synthetic response system 106 may also include suitable components such as network interfaces, security mechanisms, load balancers, failover servers, management-and-network-operations consoles, other suitable components, or any suitable combination thereof.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with fewer or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
receiving, from a client device, a query for informational responses from an audience of respondents;
generating, using a large language model and in response to the query, a set of informational responses from a set of synthetic respondents; and
providing, for display on the client device, a presentation of the set of informational responses from the set of synthetic respondents.

2. The method of claim 1,
further comprising collecting an additional set of informational responses from a set of client devices associated with human respondents,
wherein providing the presentation of the set of informational responses from the set of synthetic respondents comprises providing the presentation of the set of informational responses from the set of synthetic respondents and the additional set of informational responses from the set of client devices associated with the human respondents.

3. The method of claim 1, wherein:
receiving the query for the informational responses from the audience of respondents comprises receiving the query for the informational responses for a target context that includes at least one of a target industry, a target industry segment, a target use case, or a target brand; and
generating the set of informational responses from the set of synthetic respondents using the large language model comprises generating the set of informational responses from the set of synthetic respondents using a general population large language model and one or more low-rank adaptation adapters that adapt the general population large language model to the target context.

4. The method of claim 1, wherein:
receiving the query for the informational responses from the audience of respondents comprises receiving one or more constraints that define an audience segment; and
generating, using the large language model, the set of informational responses from the set of synthetic respondents comprises generating, using the large language model, the set of informational responses from a plurality of synthetic respondents from the audience segment.

5. The method of claim 1,
further comprising learning parameters for the large language model using value-based training data that aligns with a set of standards for generating informational responses,
wherein generating, using the large language model in response to the query, the set of informational responses comprises generating, using the large language model in response to the query, the set of informational responses to adhere to the set of standards reflected by the value-based training data.

6. The method of claim 1, further comprising:
generating, using a persona generation model, a plurality of personas for a plurality of synthetic respondents; and
learning parameters for the large language model using training data that includes ground truth data reflective of predicted responses to training queries from the plurality of personas,
wherein generating, using the large language model, the set of informational responses from the set of synthetic respondents comprises generating, using the large language model, at least one informational response from at least one synthetic respondent having a persona from the plurality of personas.

7. The method of claim 1, further comprising updating parameters of the large language model using human-based training data that includes at least one of survey data, behavioral data, or social data.

8. The method of claim 1, further comprising:
determining, using an additional machine learning model, evaluations for the informational responses from the set of synthetic respondents generated by the large language model; and
updating parameters of the large language model based on the evaluations.

9. A non-transitory computer-readable medium storing instructions that, when executed by at least one processor, cause a computer device to:
receive, from a client device, a query for informational responses from an audience of respondents;
generate, using a large language model and in response to the query, a set of informational responses from a set of synthetic respondents; and
provide, for display on the client device, a presentation of the set of informational responses from the set of synthetic respondents.

10. The non-transitory computer-readable medium of claim 9, further comprising instructions that, when executed by the at least one processor, cause the computer device to:
collect an additional set of informational responses from a set of client devices associated with human respondents; and
provide the presentation of the set of informational responses from the set of synthetic respondents by providing the presentation of the set of informational responses from the set of synthetic respondents and the additional set of informational responses from the set of client devices associated with the human respondents.

11. The non-transitory computer-readable medium of claim 9, further comprising instructions that, when executed by the at least one processor, cause the computer device to:
receive the query for the informational responses from the audience of respondents by receiving the query for the informational responses for a target context that includes at least one of a target industry, a target industry segment, a target use case, or a target brand; and
generate the set of informational responses from the set of synthetic respondents using the large language model by generating the set of informational responses from the set of synthetic respondents using a general population large language model and one or more low-rank adaptation adapters that adapt the general population large language model to the target context.

12. The non-transitory computer-readable medium of claim 9, further comprising instructions that, when executed by the at least one processor, cause the computer device to:
receive the query for the informational responses from the audience of respondents by receiving one or more constraints that define an audience segment; and
generate, using the large language model, the set of informational responses from the set of synthetic respondents by generating, using the large language model, the set of informational responses from a plurality of synthetic respondents from the audience segment.

13. The non-transitory computer-readable medium of claim 9, further comprising instructions that, when executed by the at least one processor, cause the computer device to:
learn parameters for the large language model using value-based training data that aligns with a set of standards for generating informational responses; and
generate, using the large language model in response to the query, the set of informational responses by generating, using the large language model in response to the query, the set of informational responses to adhere to the set of standards reflected by the value-based training data.

14. The non-transitory computer-readable medium of claim 9, further comprising instructions that, when executed by the at least one processor, cause the computer device to:
generate, using a persona generation model, a plurality of personas for a plurality of synthetic respondents;
learn parameters for the large language model using training data that includes ground truth data reflective of predicted responses to training queries from the plurality of personas; and
generate, using the large language model, the set of informational responses from the set of synthetic respondents by generating, using the large language model, at least one informational response from at least one synthetic respondent having a persona from the plurality of personas.

15. The non-transitory computer-readable medium of claim 9, further comprising instructions that, when executed by the at least one processor, cause the computer device to update parameters of the large language model using human-based training data that includes at least one of survey data, behavioral data, or social data.

16. The non-transitory computer-readable medium of claim 9, further comprising instructions that, when executed by the at least one processor, cause the computer device to:
determine, using an additional machine learning model, evaluations for the informational responses from the set of synthetic respondents generated by the large language model; and
update parameters of the large language model based on the evaluations.

17. A system comprising:
at least one processor; and
at least one non-transitory computer-readable storage medium storing instructions that, when executed by the at least one processor, cause the system to:
receive, from a client device, a query for informational responses from an audience of respondents;
generate, using a large language model and in response to the query, a set of informational responses from a set of synthetic respondents; and
provide, for display on the client device, a presentation of the set of informational responses from the set of synthetic respondents.

18. The system of claim 17, further comprising instructions that, when executed by the at least one processor, cause the system to:
collect an additional set of informational responses from a set of client devices associated with human respondents; and
provide the presentation of the set of informational responses from the set of synthetic respondents by providing the presentation of the set of informational responses from the set of synthetic respondents and the additional set of informational responses from the set of client devices associated with the human respondents.

19. The system of claim 17, further comprising instructions that, when executed by the at least one processor, cause the system to:
receive the query for the informational responses from the audience of respondents by receiving the query for the informational responses for a target context that includes at least one of a target industry, a target industry segment, a target use case, or a target brand; and
generate the set of informational responses from the set of synthetic respondents using the large language model by generating the set of informational responses from the set of synthetic respondents using a generalized large language model and one or more low-rank adaptation adapters that adapt the generalized large language model to the target context.

20. The system of claim 17, further comprising instructions that, when executed by the at least one processor, cause the system to:
receive the query for the informational responses from the audience of respondents by receiving one or more constraints that define an audience segment; and
generate, using the large language model, the set of informational responses from the set of synthetic respondents by generating, using the large language model, the set of informational responses from a plurality of synthetic respondents from the audience segment.
